(19) United States
(12) Patent Application Publication
(10) Pub. No.: US 2005/0164792 A1
(43) Pub. Date: Jul. 28, 2005

(54) System and method for conducting a fantasy sports draft

(76) Inventor: Joe Wilcock, Las Vegas, NV (US)

Correspondence Address: WEISS & MOY PC, 4204 NORTH BROWN AVENUE, SCOTTSDALE, AZ, 85251, US

(21) Appl. No.: 10/765,684

(22) Filed: Jan. 27, 2004

(51) Int. Cl. A63F 13/00

(52) U.S. Cl. 463/42

(57) ABSTRACT

A system and method for conducting a fantasy sports draft. Participants in a fantasy draft are gathered in a single physical location for the conduct of the draft. Team information and player selections are input into a computerized system, which displays team rosters and other desired information on display monitors so that participants can observe the draft process.

### FIELD OF THE INVENTION

This invention relates generally to systems and methods for conducting fantasy sports drafts and, more particularly, to a system and method for conducting a fantasy sports draft in which draft participants are present in a single location and team rosters generated as a result of the draft are electronically, visually displayed.

### BACKGROUND OF THE INVENTION

Fantasy sports leagues are known to fans of major sports leagues such as the National Football League, National Basketball Association, and the like. Typically, a league is created having a plurality of participating teams. The participants (i.e., team owners) gather before the start of the corresponding league season to draft players for their fantasy teams. Often, such gatherings occur in a lounge or bar setting, where participants can relax, drink, joke, and in general enjoy the draft experience.

The rules can vary from fantasy league to fantasy league. In general, each participating team is permitted to draft a certain number of players, at certain positions, to create a roster. For example, a typical fantasy football team might have two quarterbacks, four running backs, six receivers, two kickers, and two special teams.

With respect to the conduct of the draft, this can occur in one of several ways. For example, there can be a “straight” draft, in which player selection proceeds according to an established order until each team's full roster is picked. An auction draft proceeds differently. In an auction draft, teams are allowed to spend a prescribed sum of money to assemble their team, which is typically referred to as a salary cap. Players are then auctioned, with participants purchasing desired players. Each player picked and the amount bid for that player counts against the salary cap.

With respect to a straight draft, one challenge is for participants to keep track of players selected, so that time is not wasted choosing a player who has already been drafted. With respect to auction drafts, there is still a need to track players who have been selected, and also to track the amount of money that participants have spent and have left to spend. In the manner that live drafts are commonly conducted, manually tracking such information can be difficult.

### SUMMARY OF THE INVENTION

In accordance with one embodiment of the present invention, a fantasy sports drafting system is disclosed. It comprises, in combination: a computer server having fantasy sports drafting software loaded thereon; a plurality of personal computers in communication with the computer server; a plurality of display monitors, coupled to the personal computers; wherein the fantasy sports drafting software permits execution of the following steps: inputting of identifying information relating to teams participating in a fantasy draft; inputting information regarding player selections occurring during the fantasy draft; generating a roster for each team; and displaying each roster on the display monitor.

In accordance with another embodiment of the present invention, a method for conducting a fantasy sports draft is disclosed. It comprises the steps of: inputting of identifying information relating to teams participating in a fantasy draft; inputting information regarding player selections occurring during the fantasy draft; generating a roster for each team; displaying each roster on at least one display monitor so that it may be viewed by a plurality of participants in the fantasy draft; wherein the at least one display monitor is co-located with the plurality of participants in the fantasy draft.

### BRIEF DESCRIPTION OF THE DRAWINGS

FIG. 1 is a block diagram illustrating a fantasy sports draft system consistent with an embodiment of the present invention.

FIG. 2 is a flow-chart, illustrating steps in a fantasy sports draft method consistent with an embodiment of the present invention.

### DETAILED DESCRIPTION OF THE PREFERRED EMBODIMENTS

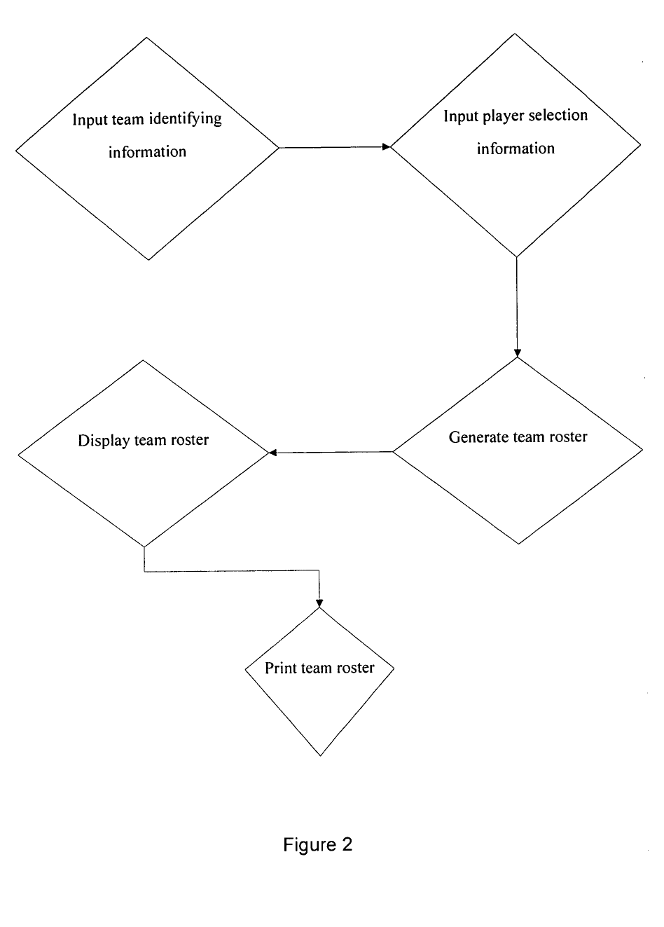

Referring first to FIG. 2, an embodiment of the fantasy sports draft method of the present invention is described. In order to practice this method, it is required to provide display monitors, such as television screens, computer monitors, or the like, which are co-located with draft participants within a single physical location such as a lounge, bar, private home, or other desired location. The display monitors should be visible to preferably all of the draft participants. The display monitors display individual team rosters, for each participating team, created as a result of the draft process. Preferably, the rosters are displayed as they are being assembled, so that participants can see how the rosters are taking shape and, perhaps, adjust their drafting strategy accordingly.

It is possible to display a single team roster on a single display monitor. It is also possible to display a group of two or more rosters on a single display monitor, particularly where the display monitor has a large display surface. This results in all of the league's rosters being displayed for simultaneous viewing of each team's picks. This makes the process of viewing team rosters more straightforward and less complicated.

In addition or alternatively, it may be desired to permit participants to enter appropriate commands into a personal computer, to pull up a desired team roster, which may be displayed one at a time or two or more at a time.

Preferably, as participants draft players for their team, each additional player is added to the roster and displayed on the corresponding display monitor for that roster. Preferably, the display monitor at least shows the fantasy team name, player name, and player position. The display monitor may further display the participant/owner name(s). Still further, where there is an auction draft, it would be preferred to display on the display monitor the amount of money spent on each player, and further to display the amount of money still available to be spent on additional players, for fantasy leagues where there is a salary cap or the like. Such information allows players to keep better track of their own progress, as well as that of other teams, and can help avoid embarrassing mistakes, such as the running out of money before the team roster is filled or the drafting of a player who has already been selected.

Preferably, the draft is conducted in a single physical location, such as a bar or lounge. In such a setting, the display monitors should be positioned so that they may be readily viewed by all of the draft participants.

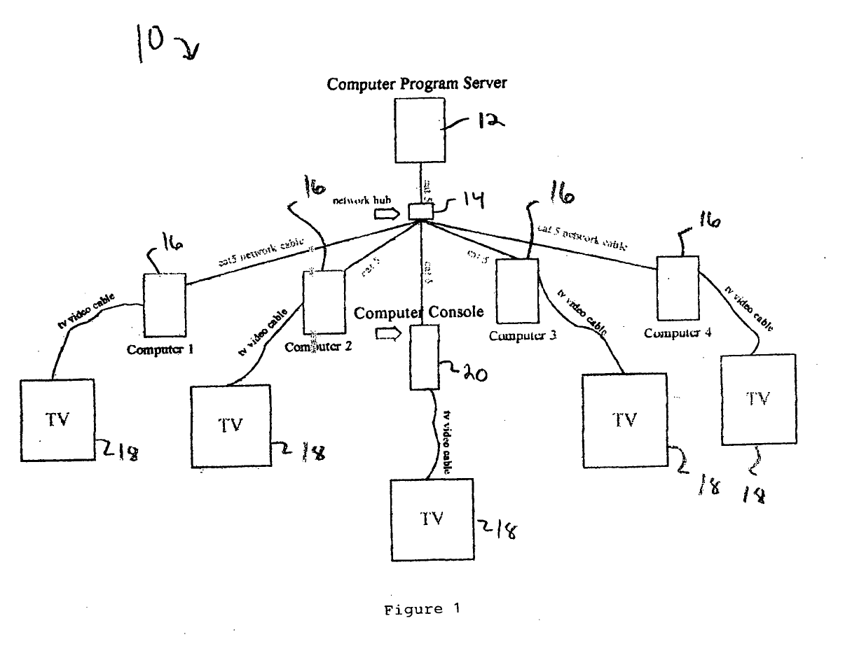

Referring now to FIG. 1, a configuration of a system 10 consistent with an embodiment of the present invention is shown. In this configuration, the system is organized as a local area network. Its components include a server 12 coupled to a hub 14. A plurality of computers 16 are coupled to the hub 14. Each computer 16 may have at least one display monitor 18 coupled thereto, and if desired a device(s) (such as a keyboard and mouse) for inputting information directly into the connected computer 16. The display monitor 18 is preferably a television screen, such as a flat screen television. A console 20, preferably having a display monitor 18 and mouse (not shown) and keyboard (not shown) coupled thereto, is additionally coupled to the hub 14. As illustrated in FIG. 1, the purpose of the hub 14 is to facilitate communication between a plurality of computers 16 and the server 12. It should be noted that such communication may be accommodated through configurations different than that illustrated here.

In this configuration, it is preferred to locate on the server 12 the software necessary to operate the fantasy draft method as herein described. The console 20 is the preferred location for the inputting of information regarding a particular fantasy draft, though inputting may occur at each computer 16. The information that may be inputted may include, for example, participant name, team name, players selected, positions of player selected, and money spent. This information may be relayed to the server 12 via hub 14. The server 12 organizes the inputted information, and communicates it in a desired format to the computers 16 via hub 14, for display on display monitors 18. Additionally, individual participants could have the ability, at their computer 16, to vary the display at the corresponding display monitor 18, to display a particular roster, perhaps particular information relating to the conduct of the draft, or as otherwise desired.

It is desired that the software operating on the server 12 have the capacity, for auction drafts, to calculate the amount of money available to be spent by participants in the assembly of their team, and that it continue to update this information as the draft progresses. For example, if a participant is limited to spending $100 on the assembly of his or her team, and spends $10 on the first player selected, the server 12 should calculate that the participant has $90 available for future selections, and this information should be displayed on the display monitors 18.

It is preferred to provide at least one printer (not shown) as part of the system 10. The printer may be utilized to print copies of team rosters at the conclusion of the draft. In addition, or alternatively, information related to a particular draft may be downloaded to a server associated with a desired web-site, to be subsequently retrieved by draft participants via the Internet.

Preferably, the computers 16 and display monitors 18 are permanently located in the setting (for example bar of lounge) where the draft occurs. However, it is possible that the computers 16 and display monitors 18 may be laptop computers or the like, which participants bring with them to the draft and couple to the hub 14. (It should be noted that the local area network shown in FIG. 1 may be wireless, wired, or some combination thereof.)

It may be desired to provide a capability for participants who are offsite to log on and participate, utilizing a personal computer, laptop, or the like. Such capacity would permit a person who is not located in the physical location where the draft is to occur to connect to the system 10 and participate. The off-site participant could receive on his or her computer information regarding the selections and rosters of other teams, could be able to input his or her selections, and could be able to view the assembly of his or her own roster.

The system and method of the present invention may be utilized with virtually any type of fantasy league. This may include football, baseball, golf, basketball, auto racing, and golf, for example.

While the invention has been particularly shown and described with reference to preferred embodiments thereof, it will be understood by those skilled in the art that the foregoing and other changes in form and details may be made therein without departing from the spirit and scope of the invention.

1. A fantasy sports drafting system comprising, in combination:
a computer server having fantasy sports drafting software loaded thereon;
a plurality of personal computers in communication with said computer server;
a plurality of display monitors, coupled to said personal computers;
wherein said fantasy sports drafting software permits execution of the following steps:
inputting of identifying information relating to teams participating in a fantasy draft;
inputting information regarding player selections occurring during said fantasy draft;
generating a roster for each said team; and
displaying each said roster on said display monitor.

2. The system of claim 1, further comprising a hub interposed between said computer server and said plurality of personal computers.

3. The system of claim 1 further comprising a console in communication with said computer server.

4. The system of claim 3 wherein said console is coupled to said hub.

5. The system of claim 1 wherein said identifying information includes a team name.

6. The system of claim 5 wherein said identifying information further includes a participant name.

7. The system of claim 1 wherein said player selections information includes a name and position of a player selected during said fantasy draft.

8. The system of claim 1, wherein said fantasy sports drafting software further permits execution of the step of inputting information regarding an amount spent to select a player during said draft.

9. The system of claim 8, wherein said fantasy sports drafting software further permits execution of the step of calculating an amount of money available to be spent by a participant in said draft.

10. A method for conducting a fantasy sports draft comprising the steps of:
inputting of identifying information relating to teams participating in a fantasy draft;
inputting information regarding player selections occurring during said fantasy draft;
generating a roster for each said team;
displaying each said roster on at least one display monitor so that it may be viewed by a plurality of participants in said fantasy draft;
wherein said at least one display monitor is co-located with said plurality of participants in said fantasy draft.

11. The method of claim 10 wherein said identifying information includes a team name.

12. The method of claim 11 wherein said identifying information further includes a participant name.

13. The method of claim 10 wherein said player selections information includes a name and position of a player selected during said fantasy draft.

14. The method of claim 10, further comprising the step of inputting information regarding an amount spent to select a player during said draft.

15. The method of claim 14, further comprising the step of calculating an amount of money available to be spent by a participant in said draft.

16. The method of claim 10, further comprising the step of permitting at least one participant who is not co-located with said display monitors to participate in said fantasy draft.

17. The method of claim 10 further comprising the step of printing a team roster for each participating team.

18. The method of claim 10, further comprising the step of downloading to a server associated with a web-site an electronic version of at least one team roster for at least one participating team, so that it may be uploaded by at least one said participant.
